(19) United States
(12) Patent Application Publication
(10) Pub. No.: US 2011/0078001 A1
(43) Pub. Date: Mar. 31, 2011

(54) FEEDBACK SYSTEM FOR TELEVISION ADVERTISEMENTS

(75) Inventors: Donald Gene Archer, Euless, TX (US); Raul Aldrey, Dallas, TX (US); Yuriy Bolyukh, Trophy Club, TX (US); Dolapo Kukoyi, Irving, TX (US); Japan A. Mehta, Irving, TX (US)

(73) Assignee: Verizon Patent and Licensing, Inc., Basking Ridge, NJ (US)

(21) Appl. No.: 12/570,371

(22) Filed: Sep. 30, 2009

(51) Int. Cl. G06Q 30/00; H04H 60/33; H04N 5/44

(52) U.S. Cl. 705/14.2; 725/13; 348/734; 705/14.19; 725/32; 725/23; 348/E05.096

(57) ABSTRACT

A video client receives an advertisement for presentation on a display and presents to a user, on the display, the advertisement and a rating interface for the advertisement. The video client receives, via the rating interface, a user input to rate the advertisement and sends, to a server, rating information based on the user input to rate the advertisement. The video client also receives, from the server, incentive information based on the rating information and presents to the user, on the display, the incentive information.

### BACKGROUND INFORMATION

As media outlets proliferate and viewing audiences become more fragmented, advertisers, such as television advertisers, are having greater difficulty capturing and holding viewer attention. Consequently, advertisements may need to more be inventive and reach beyond a traditional linear format (e.g., presented in a broadcast sequence without any sequencing control from a viewer).

### BRIEF DESCRIPTION OF THE DRAWINGS

FIG. 1 illustrates an exemplary environment for obtaining viewer feedback for television advertising;

FIG. 2 depicts an exemplary network in which systems and/or methods described herein may be implemented;

FIG. 3 is a block diagram of exemplary components of a video client that may be used in the network of FIG. 2;

FIG. 4 is a block diagram of exemplary components of a device that may correspond to a content server and/or a ranking manager of FIG. 2;

FIG. 5 depicts a diagram of exemplary interactions among components of an exemplary portion of the network illustrated in FIG. 2;

FIG. 6 illustrates a diagram of exemplary functional components of the ranking manager of FIG. 2;

FIG. 7 is a flow chart illustrating an exemplary process for obtaining viewer feedback of television advertising;

FIG. 8 is a flow chart illustrating an another exemplary process for obtaining viewer feedback of television advertising; and

FIGS. 9A and 9B are exemplary diagrams illustrating a user interface for obtaining viewer feedback of television advertising according to implementations described herein.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

Implementations described herein may provide systems and/or methods that may enable viewers to be rewarded for viewing, rating, and/or providing other feedback regarding advertisements within a television viewing environment. As described further herein, a video client (e.g., a set-top box) may present a rating interface in conjunction with an advertisement. User input (e.g., via a remote control signal) to the rating interface may be received and provided to a ratings aggregation and processing module. The ratings aggregation and processing module may provide rating information to advertisers and may manage an incentive program to encourage continued viewer participation.

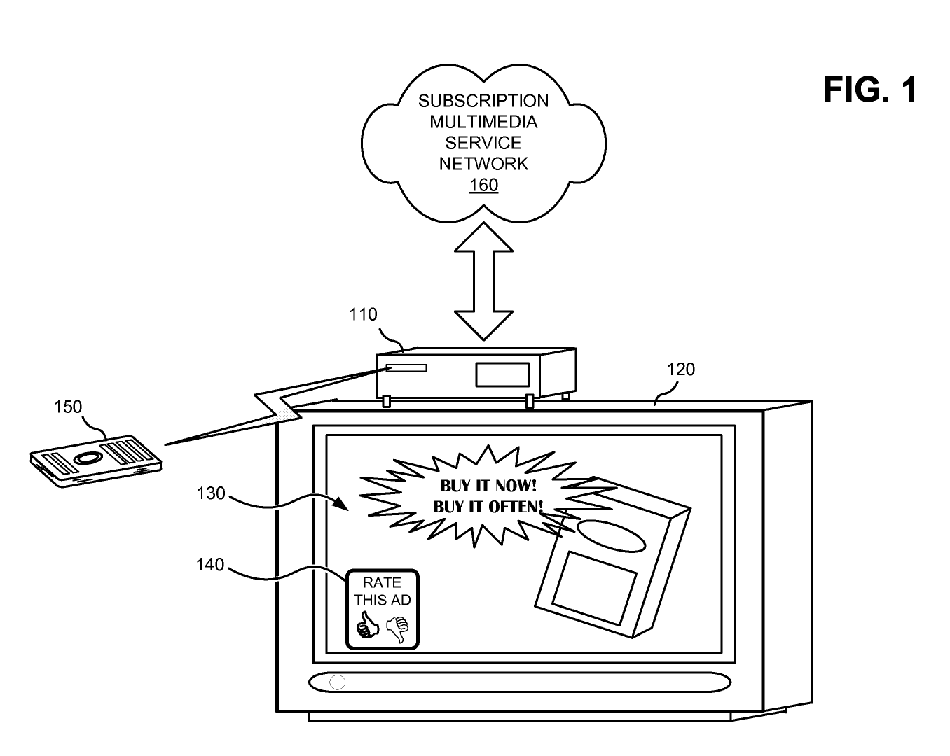

FIG. 1 illustrates an exemplary environment 100 for soliciting viewer feedback of television advertising. As shown in FIG. 1, a video client 110 may present, via a video display device 120, an advertisement 130 and a ratings interface 140. In one implementation, advertisement 130 may include a television advertisement presented within a linear format (e.g., presented in a broadcast sequence without any sequencing control from the viewer). In other implementations, advertisement 130 may be retrieved (e.g., from a menu of stored advertisements) and presented to a user on demand. Advertisements may include a variety of formats, including, for example, linear and/or interactive video, images, banners/overlays, interactive (e.g., clickable) advertisements, etc.

Rating interface 140 may include an interactive menu or another visible indicator that may be used to solicit and receive input from a user. In one implementation, as shown in FIG. 1, rating interface 140 may be overlaid on a portion of advertisement 130 and present a viewer with the opportunity to subjectively rate advertisement 130. In another implementation, rating interface 140 may be presented as a separate window adjacent to advertisement 130. Rating interface 140 may include an interactive menu that can be implemented, for example, via an Enhanced TV Binary Interchange Format (EBIF) application to allow a user to provide input via a remote control, such as remote control 150. In an exemplary implementation, rating interface 140 may be opened via an on-screen “widget” that can be selectively activated by the viewer.

Video client 110 may receive user input to rating interface 140 and may provide the rating information to one or more components within a subscription multimedia service network 160. As described further herein, components within subscription multimedia service network 160 may coordinate with advertising sources to update advertising profiles of viewers and/or video clients 110 and to manage viewer incentive programs for advertising campaigns.

In one exemplary operation, rating interface 140 may be displayed during presentation of a liner advertisement and/or for a brief period of time (e.g., less than 5 seconds) after the completion of the advertisement to allow a user time to provide input. In another exemplary operation, when a viewer activates rating interface 140 using remote control 150, advertisement 130 may be paused and subsequent linear programming may be automatically recorded while rating interface 140 remains activated so as to gracefully return a viewer to the linear programming sequence once the viewer has finished providing rating input. In still other implementations, an expanded version of rating interface 140 (e.g., allowing more detailed view input) may be presented to the viewer upon activation by a signal from remote control 150.

Video client 110 may send, for example, viewer ratings/feedback, associated advertisement identifiers, and time/channel information to a ratings aggregation and processing module within subscription multimedia service network 160. The ratings aggregation and processing module may, for example, coordinate with advertising sources/providers to update viewer/demographic profiles and manage viewer incentive programs for advertising campaigns. In an exemplary implementation, a viewer may receive coupons/discounts for sitting through a threshold number of advertisements and/or for rating the advertisements (e.g., a viewer may receive a reduction on a service provider bill for watching a few advertisements and completing a short survey). Rating interface 140 may provide messages to keep the viewer interested and motivated to continue viewing advertisements (e.g., on-screen messages such as “thank you for your vote, three more votes and you're eligible for . . . ”).

As used herein, the term “video client” may refer to any media processing device that may receive multimedia content over a network, and may provide such multimedia content to an attached video display device (such as a television or computer monitor). A “subscription multimedia service,” as used herein, may refer to television, telephone, networking and/or other multimedia services provided to customers over a closed distribution network, such as cable, optical fiber, satellite, or virtual private networks. Also, as used herein, the terms “user,” “viewer,” “subscriber,” and “customer” may refer interchangeably to a person who interacts with, orders, uploads, listens to, or plays multimedia content over a subscription multimedia service network.

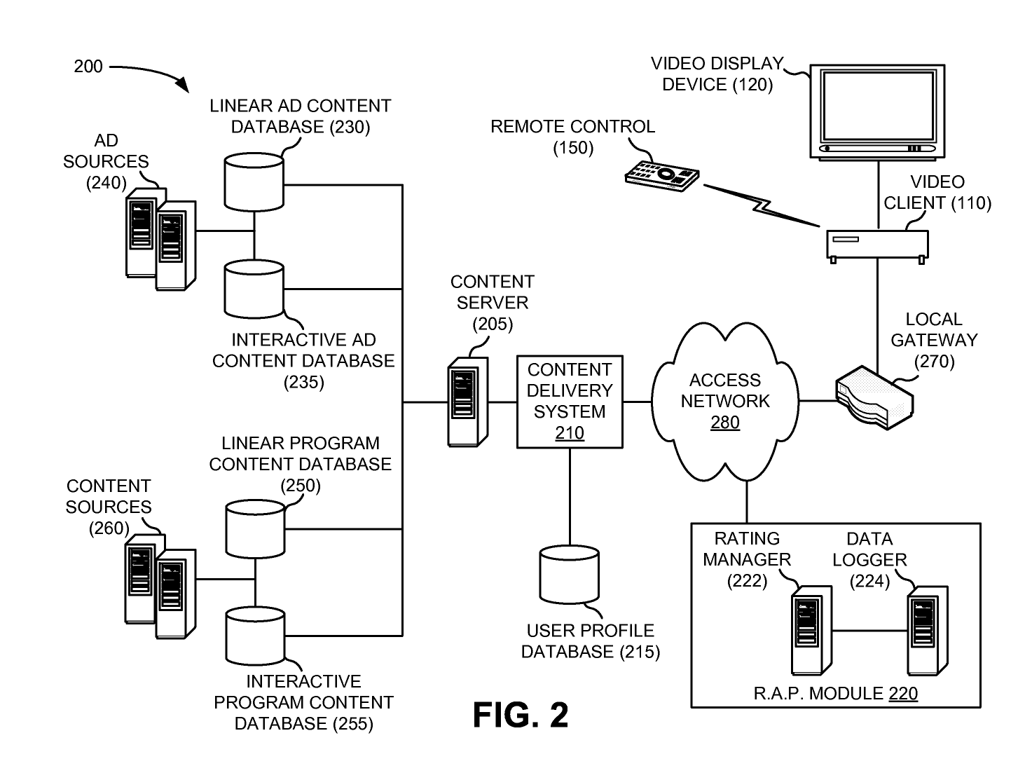

FIG. 2 is a diagram of an exemplary network 200 in which systems and/or methods described herein may be implemented. As illustrated, network 200 may include video client 110, video display device 120, remote control 150, a content server 205, a content delivery system 210, a user profile database 215, a ratings aggregation and processing (R.A.P.) module 220 that includes a rating manager 222 and a data logger 224, a linear advertising (ad) content database 230, an interactive advertising (ad) content database 235, advertising (ad) sources 240, a linear program content database 250, an interactive program content database 255, content sources 260, a local gateway 270, and an access network 280. Video client 110, video display device 120, remote control 150, and local gateway 270 may be located on a customer's premises and may be connected via access network 280 to content delivery system 210 and/or content server 205 located at, for example, a subscription multimedia service provider's premises. Components of network 200 may interconnect via wired and/or wireless connections.

For simplicity, a single video client 110, video display device 120, remote control 150, content server 205, content delivery system 210, user profile database 215, ratings aggregation and processing module 220, rating manager 222, data logger 224, linear advertising content database 230, interactive advertising content database 235, set of advertising sources 240, linear program content database 250, interactive program content database 255, set of content sources 260, local gateway 270, and access network 280 have been illustrated in FIG. 2. In practice, there may be more video clients 110, video display devices 120, remote controls 150, content servers 205, content delivery systems 210, user profile databases 215, ratings aggregation and processing modules 220, rating managers 222, data loggers 224, linear advertising content databases 230, interactive advertising content databases 235, sets of advertising sources 240, linear program content databases 250, interactive program content databases 255, sets of content sources 260, local gateways 270, and/or access networks 280. Also, in some instances, one or more of the components of network 200 may perform one or more functions described as being performed by another one or more of the components of network 200.

Video client 110 may include any device capable of receiving, transmitting and/or processing information to and/or from access network 280. In one implementation, video client 110 may be a closed device (e.g., including a hardware/software configuration that is not accessible to the general public). Video client 110 may provide video signals to video display device 120. Examples of video client 110 may include a set-top box, a computer, a cable card, and a portable electronic device (e.g., a cell phone, a personal digital assistant (PDA), etc.). Video client 110 may receive a television signal from gateway 270, may convert the signal to a form usable by video display device 120, and may transmit the signal to video display device 120 for display. Video client 110 may further allow a user to provide user input for interactive television applications (e.g., to navigate menu displays, such as rating interface 140, and/or select menu items) and to alter the programming provided to video display device 120 based on a signal (e.g., a channel up or channel down signal) received from, for example, remote control 150. In one implementation, video client 110 may support interfaces, such as rating interface 140, using Enhanced TV Binary Interchange Format (EBIF). Video client 110 may also send data to a backend server (e.g., content server 205, rating manager 222, and/or a device within content delivery system 210) via access network 280. In an exemplary implementation, video client 110 may also include an integrated digital video recorder (DVR) or other memory device that may enable video client 110 to store content for later retrieval/presentation to a user based on, for example, user interactions with rating interface 140. In some implementations, video client 110 may be incorporated within video display device 120.

Video display device 120 may include a digital or analog display via which a user may view multimedia content (including, for example, conventional programming, interactive displays, and/or advertising). Video display device 120 may refer to any device that can receive and display multimedia content delivered over access network 280 and/or through video client 110 for perception by users. Video display device 120 may include technologies, such as cathode ray tube (CRT) displays, liquid crystal displays (LCDs), light-emitting diode (LED) displays, plasma displays, etc.

Remote control 150 may include a range of devices including function specific keys, number keys, and/or a full-text key pad. A user may interact with video client 110 using a keypad that is part of remote control 150, and signals representing key depressions may be transmitted to video client 110 via an infrared transmission or another type of transmission. Remote control 150 may allow a user to navigate a program guide, select channels or programs for viewing, adjust display characteristics, and/or perform other interactive functions related to viewing multimedia-type content provided over a network. In one implementation, video client 110 may allow a user to provide input to a rating menu (e.g., rating interface 140) by using remote control 150. For example, arrow keys and a “Select” button on remote control 150 may be used to highlight and select indicators for particular rating levels (e.g., qualitative rating levels such as “like” and “don't like,” or quantitative ranges such as a scale of 1 to 5). As another example, remote control 150 may include an “A,” a “B,” and a “C” shortcut button, where pressing each button may toggle between select a rating level or toggle between ratings. In another exemplary implementation (e.g., if video client 110 corresponds to a computer, a portable electronic device, etc.), remote control 150 may be omitted and a user may interact with video client 110 via input mechanisms (e.g., a keyboard, keypad, a touch screen, etc.) associated with video client 110.

Content server 205 may include one or more devices for providing content/information to video client 110 and/or video display device 120 in accordance with requests that are issued from video client 110. Examples of content server 205 may include a headed device that provides pay-per-view (PPV) events, a video-on-demand (VOD) device or another device that provides multimedia content upon request, an advertising server that provides advertising associated with multimedia content, and/or a program guide information server that provides information related to multimedia content available to video client 110. Content server 205 may communicate with a variety of other components within network 200, such as devices within content delivery system 210, linear advertising content database 230, interactive advertising content database 235, linear program content database 250, and interactive program content database 255 to provide requested multimedia services to customers. In one implementation, content server 205 may retrieve advertising content that has been specifically requested by video client 110 based on rating campaign information provided to video client 110. While shown as a single server device in FIG. 2, in other implementations, content server 205 may be distributed among multiple server devices.

Content delivery system 210 may include one or more devices to deliver broadcast and other multimedia content to video client 110. In general, content delivery system 210 may provide control over (e.g., via access network 280) television services for devices, such as video clients 110, video display devices 120, and/or other network connectivity devices (e.g., personal computers, not shown) provided at the customer's premises. Content delivery system 210 may include, for example, video hub offices (VHOs), databases, gateways, servers, network switches, and/or routers that may be connected by wired and/or wireless connections. Content delivery system 210 may serve as a link between a video client 110 and content server 205 to enable delivery of on-demand multimedia content, advertising, applications (e.g., applications/updates for rating interface 140), etc. For example, content delivery system 210 may facilitate communications between content server 205 and video client 110 via access network 280. In one implementation, content delivery system 210 may combine broadcast programming content with advertising content (retrieved, e.g., from content server 205) to provide a combined linear content/advertising stream to video client 110. In some implementations, content delivery system 210 may also collect information from video clients 110 that may be used, for example, to generate user profiles.

User profile database 215 may include one or more devices for storing data for video client 110 or groups of video clients that may be used to provide targeted advertising and/or manage advertising campaigns. For example, advertisements may be assigned a unique advertising identifier that may be cross-referenced to particular demographics, interests, or other indicators that may be obtained from a user profiles. Advertisers may classify particular advertising content to identify demographic groups, common interests, and/or other information that can be used in determining particular video clients 110 (or groups of video clients) to which to direct the advertising content. Content delivery system 210 may retrieve user profile information from user profile database 215 and retrieve advertising content from content server 205 that has been classified to correspond to the user profile tendencies.

Ratings aggregation and processing module 220 may include one or more devices that are capable of collecting data and performing statistical analysis on user activity of video client 110 and other video clients. Ratings aggregation and processing module 220 may combine related data into groups of accounts based on, for example, pattern analysis and correlation. Ratings aggregation and processing module 220 may also manage incentive programs for viewers in conjunction with video clients 110. In implementations described herein, ratings aggregation and processing module 220 may include rating manager 222 and data logger 224.

Rating manager 222 may include one or more server devices, or other types of computation or communication devices, that gather, process, search, and/or provide information in a manner described herein. Rating manager 222 may receive advertisement rating information from video client 110 and may determine appropriate responses to viewer rating inputs. In one implementation, rating manager 222 may collect user rating information from multiple video clients 110. Rating manager 222 may aggregate user rating information to identify responses to particular advertisements and/or advertising campaigns. Rating manager 222 may also collect user response data to assemble profiles for individual video clients 110 (or accounts associated with a video client 110). For example, rating manager 222 may track how many ratings are received from a particular video client 110 and may identify viewer incentives (e.g., coupons for multimedia provider services, coupons for advertiser products/services, rebates, price reductions, access to additional content, etc.) when video client 110 indicates that a viewer has provided a particular number of rankings and/or provided a particular type of information (e.g., completed a more in-depth survey).

Data logger 224 may include one or more devices that maintain a rating history (such as user ratings of advertisements based on interactions with rating interface 140) of video client 110. In one implementation, data logger 224 may include a database of exemplary fields, such as a video client identifier, a user account identifier (e.g., for a particular user of a video client), a date field (e.g., a date the advertisement was shown or a date the user rating was provided), a time field (e.g., a time the advertisement was shown or a time the user rating was provided), one or more advertisement code(s) fields, a channel field (e.g., the current channel at the time an advertisement was rated), and/or a program identification field (e.g., the current program at the time an advertisement was rated). Data logger 224 may include multiple databases stored locally at ratings aggregation and processing module 220 and/or stored at one or more different and possibly remote locations. Data logger 224 may group viewer rating histories, for example, by individual users, user groups, demographics, etc. Information from data logger 224 may be retrieved by a backend server (or another server device) within, for example, content delivery system 210 to monitor advertising data.

Linear advertising content database 230 may include one or more devices that receive and maintain linear advertising content from advertising sources 240. Linear advertising content may include, for example, advertising content that may be inserted within a break in linear programming (e.g., a conventional commercial break in broadcast programming). Interactive advertising content database 235 may include one or more devices that receive and maintain interactive advertising content from advertising sources 240. Interactive advertising content may include, for example, non-linear advertising that may be presented, for example, based directly or indirectly on user input to video client 110. Non-liner advertising may include, for example, interactive applications, widgets, and/or other multimedia that may not be time-restricted.

Advertising sources 240 may include one or more server devices, or other types of computation or communication devices, that gather, process, search, and/or provide information in a manner described herein. Advertising sources 240 may provide linear and interactive advertising content to linear advertising content database 230 and/or interactive advertising content database 235. In an exemplary implementation, advertising sources 240 may be controlled by one or more different devices than the device that controls linear advertising content database 230 and/or interactive advertising content database 235 (e.g., the subscription multimedia service provider). In an exemplary implementation, rating information from ratings aggregation and processing module 220 may be provided to advertising sources 240.

Linear program content database 250 and interactive program content database 255 may each include one or more devices that receive and maintain linear program content and interactive program content, respectively, from content sources 260. Linear program content may include, for example, pay-per-view programming. Interactive program content may include non-linear programming that may be selected and/or controlled by a user, such as interactive applications, games, etc.

Content sources 260 may include one or more server devices, or other types of computation or communication devices, that gather, process, search, and/or provide information in a manner described herein. Content sources 260 may provide linear and interactive program content to linear program content database 250 and/or interactive program content database 255. In an exemplary implementation, content sources 260 may be controlled by one or more different operating entities than the entity that controls linear program content database 250 and/or interactive program content database 255 (e.g., the subscription multimedia service provider).

Local gateway 270 may include a network device that provides an interface from access network 280 to video clients 110 and/or other network connectivity devices (not shown). For example, when telecommunication services are provided to a customer's premises via an optical fiber, gateway 270 may include an optical network terminal (ONT) that connects to the optical fiber. The ONT may convert between signals appropriate for video display device 120 and signals appropriate for transmission over optical fiber. For example, the ONT may include a coaxial cable connection that leads to video display device 120 or video client 110. The ONT may also include an Ethernet output port that connects to a personal computer or a voice over Internet protocol (VoIP) telephone and/or a standard telephone port for connecting to a standard telephone. Gateway 270 may include one of a number of possible gateway devices, including a satellite antenna and receiver, a coaxial cable connection, an ONT, or a broadband access for Internet Protocol TV (IPTV). The satellite antenna and receiver may provide an interface for television services broadcast from satellites. The coaxial cable connection may provide an interface for television services connected to a customer via coaxial cables. The ONT may provide an interface for an optical fiber connection. The broadband IPTV access may generally include any device that provides broadband access over which television service may be provided.

Access network 280 may include a video signaling and distribution network and system that permit transfer of data between backend servers and video clients 110. Additionally, access network 280 may include, among other things, a firewall, a filtering mechanism, a proxy, and/or network address translation mechanisms. Access network 280 may include, for example, a single network, such as a wide area network (WAN), a local area network (LAN), a metropolitan area network (MAN), a telephone network (e.g., a public switched telephone network (PSTN) or a wireless network), the Internet, a satellite network, etc., or a combination of networks. Access network 280 may provide customers with multimedia content provided, for example, by content server 205 and/or content delivery system 210.

In implementations described herein, video client 110 may receive programming from content delivery system 210. The programming may include advertisements that may be rated by users of video client 110. Video client 110 may display the advertisements (e.g., advertisement 130) to a user via video display device 120. Prior to or during an advertising break in the programming, a user may activate a rating interface (e.g., rating interface 140). During presentation of an advertisement, the rating interface may be simultaneously displayed with the advertisement. A user may select, via remote control 150, a rating for the advertisement using the rating interface. Video client 110 may provide an indication of the user's rating to rating manager 222 via access network 280. Rating manager 222 may store the user rating and identify an appropriate response to the user input based on, for example, particular incentive criteria. The appropriate response may include, for example, identification of a particular reward or change of status (e.g., within the incentive program) for the user. Rating manager 222 may aggregate user rating information for advertisements and store the information in data logger 224. Portions of aggregated rating information may be provided to appropriate advertising sources (e.g., advertising sources 240). Rating manager 222 may also generate/update advertisement viewing profiles for particular video clients and/or groups of video clients.

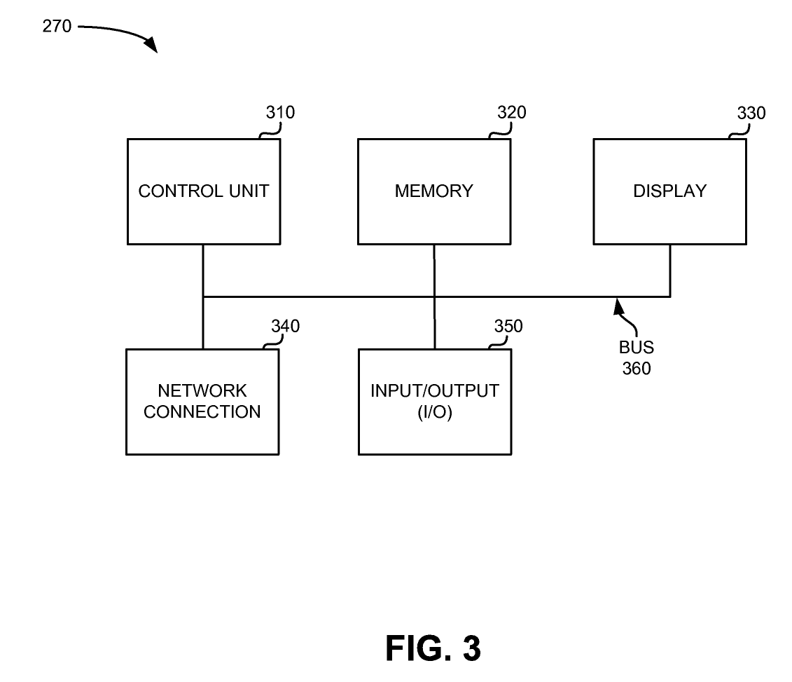

FIG. 3 is diagram illustrating exemplary components of video client 110. As shown, video client 110 may include a control unit 310, a memory 320, a display 330, a network connection 340, an input/output (I/O) component 350, and a bus 360.

Control unit 310 may include one or more processors, microprocessors, or another type of processing logic that interprets and executes instructions. Among other functions, control unit 310 may generate an advertisement rating interface (e.g., rating interface 140) and may collect and store viewer input associated with rating interface. Control unit 310 may execute instructions to send viewer input to another device, such as rating manager 222. Control unit 310 may also receive information and/or instructions from other devices, such as rating manager 222 and/or content delivery system 210.

Memory 320 may include one or more dynamic or static storage devices that may store information and instructions for execution by control unit 310. For example, memory 320 may include a storage component, such as a random access memory (RAM), a dynamic random access memory (DRAM), a static random access memory (SRAM), a synchronous dynamic random access memory (SDRAM), a ferroelectric random access memory (FRAM), a read only memory (ROM), a programmable read only memory (PROM), an erasable programmable read only memory (EPROM), an electrically erasable programmable read only memory (EEPROM), and/or a flash memory. Memory 320 may also include a component that may include a magnetic and/or optical recording medium to implement, for example, DVR functionality. In one implementation, memory 320 may store a rating activity log to send at a later point in time, such as when requested by rating manager 222.

Display 330 may include any component capable of providing visual information. For example, in one implementation, display 330 may be a light emitting diode (LED) or a liquid crystal display (LCD). In another implementation, display 330 may use another display technology, such as a dot matrix display, etc. Display 330 may display, for example, text (such as a time, a date, or a channel selection), images, and/or video information.

Network connection 340 may include any transceiver-like mechanism that enables video client 110 to communicate with other devices and/or systems, such as content delivery system 210 and/or rating manager 222. For example, network connection 340 may include an Ethernet interface, an optical interface, a coaxial interface, a radio interface, or the like. Network connection 340 may allow for wired and/or wireless communication.

Input/output devices 350 may generally include user input devices, such as external buttons, and output devices, such as LED indicators. With input/output devices 350, a user may generally interact with video client 110. In some implementations, input/output devices 350 may be implemented via a remote control (e.g., remote control 150). Bus 360 may provide an interface through which components of video client 110 can communicate with one another.

As will be described in detail below, video client 110 may perform certain operations relating to displaying information and communicating viewer activities to a server, such as rating manager 222. Video client 110 may perform these operations in response to control unit 310 executing software instructions contained in a computer-readable medium, such as memory 320. A computer-readable medium may be defined as a physical or logical memory device. A logical memory device may refer to memory space within a single, physical memory device or spread across multiple, physical memory devices. The software instructions may be read into memory 320 from another computer-readable medium or from another device. The software instructions contained in memory 320 may cause control unit 310 to perform processes that will be described later. Alternatively, hardwired circuitry may be used in place of or in combination with software instructions to implement processes described herein. Thus, implementations described herein are not limited to any specific combination of hardware circuitry and software.

Although FIG. 3 illustrates exemplary components of video client 110, in other implementations, video client 110 may include fewer, different, differently arranged, or additional components than those depicted in FIG. 3. In still other implementations, one or more components of video client 110 may perform one or more other tasks described as being performed by one or more other components of video client 110.

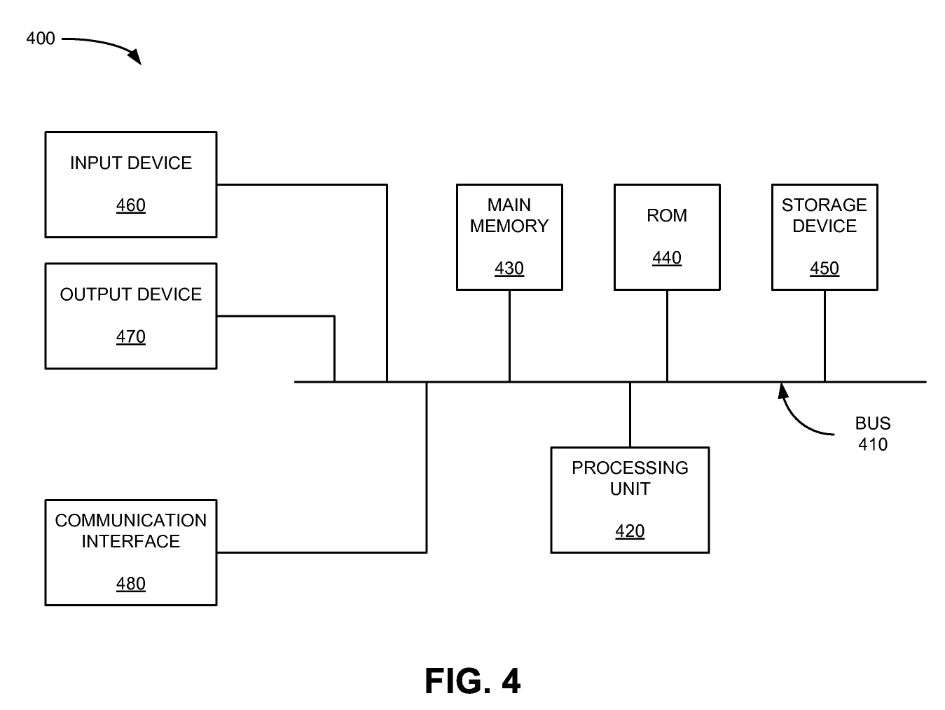

FIG. 4 is a diagram of exemplary components of a device 400 that may correspond to content server 205 and/or rating manager 222. In some implementations, device 400 may also correspond to one or more of data logger 224, advertising sources 240, content sources 260, and certain components of content delivery system 210. As illustrated, device 400 may include a bus 410, a processing unit 420, a main memory 430, a read-only memory (ROM) 440, a storage device 450, an input device 460, an output device 470, and a communication interface 480.

Bus 410 may include a path that permits communication among the components of device 400. Processing unit 420 may include one or more processors, microprocessors, or other types of processing units, such as application-specific integrated circuits (ASICs), field-programmable gate arrays (FPGAs), etc., that may interpret and execute instructions.

Main memory 430 may include a RAM or another type of dynamic storage device that stores information and instructions for execution by processing unit 420. ROM 440 may include a ROM device or another type of static storage device that may store static information and instructions for use by processing unit 420. Storage device 450 may include a magnetic and/or optical recording medium and its corresponding drive. Storage device 450 may store viewer transaction history for particular video clients 110 and/or all video clients 110 associated with a subscription multimedia service provider.

Input device 460 may include a mechanism that permits an operator to input information to device 400, such as a keyboard, a mouse, a pen, voice recognition and/or biometric mechanisms, a touch-screen interface, etc. Output device 470 may include a mechanism that outputs information to the operator, including a display, a printer, a speaker, etc. Communication interface 480 may include any transceiver-like mechanism that enables device 400 to communicate with other devices and/or systems, such as video client 110.

As will be described in detail below, device 400 may perform certain operations associated with providing soliciting, collecting, and distributing view feedback for advertisements within a subscription multimedia service. Device 400 may perform these and other operations in response to processing unit 420 executing software instructions contained in a computer-readable medium, such as main memory 430. The software instructions may be read into main memory 430 from another computer-readable medium, such as storage device 450, or from another device via communication interface 480. The software instructions contained in main memory 430 may cause processing unit 420 to perform processes that will be described later. Alternatively, hardwired circuitry may be used in place of, or in combination with, software instructions to implement processes consistent with exemplary implementations. Thus, implementations described herein are not limited to any specific combination of hardware circuitry and software.

Although FIG. 4 illustrates exemplary components of device 400, in other implementations, device 400 may include fewer, different, differently arranged, or additional components than those depicted in FIG. 4. In still other implementations, one or more components of device 400 may perform one or more other tasks described as being performed by one or more other components of device 400.

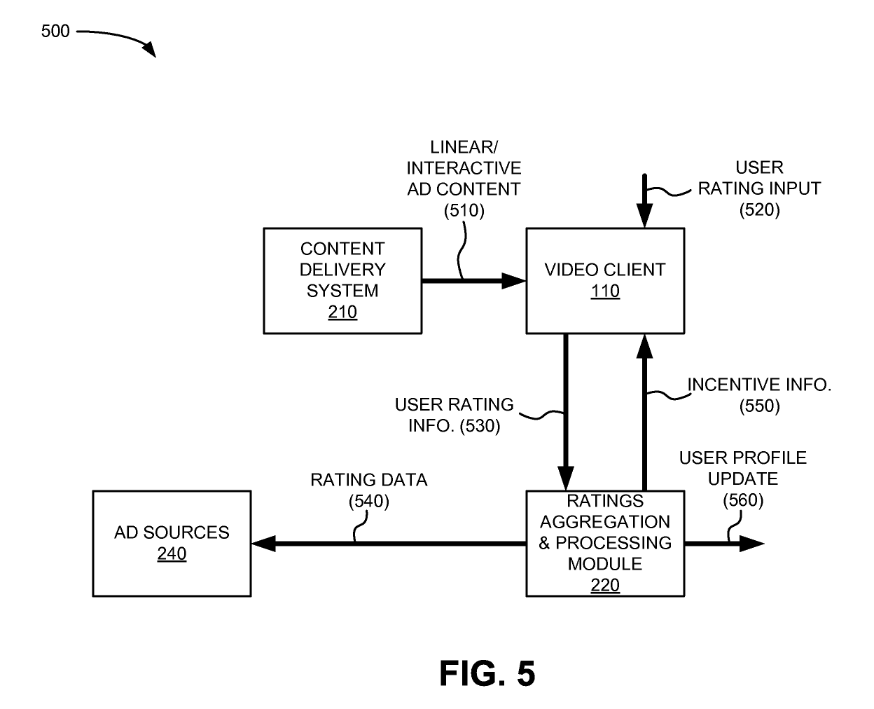

FIG. 5 depicts a diagram of exemplary interactions among components of an exemplary portion 500 of network 200. As illustrated, exemplary network portion 500 may include video client 110, content delivery system 210, ratings aggregation and processing module 220, and ad sources 240. Video client 110, content delivery system 210, ratings aggregation and processing module 220, and ad sources 240 may include the features described above in connection with, for example, FIGS. 1-4.

As further shown in FIG. 5, content delivery system 210 may provide linear/interactive advertising content 510 to video client 110. For example, in one implementation, content delivery system 210 may combine linear advertising content with linear broadcast content and send the combined content to video client 110 via access network 280. In one implementation, linear/interactive advertising content 510 may be supplied to content delivery system 210 via content server 205, linear advertising content database 230, and/or interactive advertising content database 235 (not shown in FIG. 5). In one implementation, linear/interactive advertising content 510 may be provided to video client 110 as a single video stream integrated with particular program content. In another implementation, content delivery system 210 may provide linear/interactive advertising content 510 separate from any program content, so that linear/interactive advertising content 510 may later be associated with the program content by video client 110.

Video client 110 may receive linear/interactive advertising content 510 and may cause the advertising content to be displayed to a user (e.g., via video display device 120). When an advertisement is displayed, video client 110 may also initiate display of a rating interface (e.g., rating interface 140). A viewer may provide a user rating input 520 to video client 110 via the rating interface. User rating input 520 may be provided via a remote control (e.g., remote control 150).

Video client 110 may identify user rating input 520 and associate user rating input 520 with an identification code for the advertisement, time/channel information, an identification code for video client 110, and/or other contextual information. Video client 110 may compile the identification code for the advertisement, time/channel information, identification code for video client 110, and/or other contextual information and send the compiled user rating information to ratings aggregation and processing module 220, as indicated by reference number 530. In one implementation, user rating information 530 may be provided to ratings aggregation and processing module 220 in real time (or near real time). In other implementations, user rating information 530 may be provided as a batch of rating inputs (e.g., provided at particular intervals and/or when requested by ratings aggregation and processing module 220). Thus, in some implementations, video client 110 may receive and store criteria for a rating incentive program and monitor metrics from the user input against the stored criteria in order to provide real-time feedback to a viewer regarding the viewer's incentive/reward status.

Ratings aggregation and processing module 220 may receive user rating information 530, compile user rating information 530 with other user rating information, and update viewer/video client profiles. In one implementation, ratings aggregation and processing module 220 may provide rating data 540 to advertisers (such as ad sources 240), content providers (such as content sources 260), or others systems within or outside of network 200. Rating data 540 may be provided in a variety of formats and may be combined with other data retrieved from video clients 110. Rating data 540 may include, for example, an indication of a particular advertisement's popularity based on the number to total viewer responses received and/or the number of positive viewer responses.

Ratings aggregation and processing module 220 may also determine an appropriate response to user rating information 530 based on, for example, a set of incentive rules and/or prevailing environmental/contextual metrics (e.g., time of day, program being viewed, etc.). Based on the appropriate response determined by ratings aggregation and processing module 220, ratings aggregation and processing module 220 may provide incentive information 550 to video client 110. Rating manager 222 of ratings aggregation and processing module 220 may, for example, instruct video client 110 to announce a particular reward (e.g., coupons, rebates, price reductions, access to additional content, etc.) available to a viewer and/or a status of progress toward a particular reward.

In an exemplary implementation, ratings aggregation and processing module 220 may also capture metrics regarding user rating information 530. For example, rating manager 222 of ratings aggregation and processing module 220 may identify advertisement codes, user ratings, contextual parameters, and/or other information that may be relevant to advertisers and/or system managers. The advertisement codes, user ratings, contextual parameters, and/or other information may be compiled as updates for a user profile related to video client 110. As indicated by reference number 560, ratings aggregation and processing module 220 may send the updates for a user profile to another location either within ratings aggregation and processing module 220 (e.g., data logger 224) or to another data collection/analyzing component within network 200.

Although FIG. 5 shows exemplary components of network portion 500, in other implementations, network portion 500 may contain fewer, different, differently arranged, or additional components than depicted in FIG. 5. In still other implementations, one or more components of network portion 500 may perform one or more other tasks described as being performed by one or more other components of network portion 500.

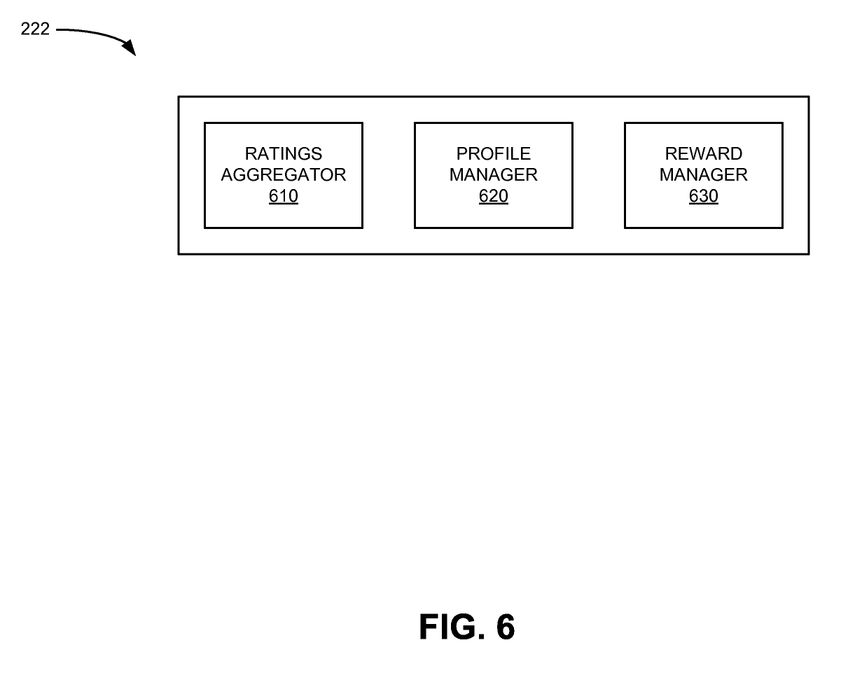

FIG. 6 depicts a diagram of exemplary functional components of rating manager 222. In one implementation, the functions described in connection with FIG. 6 may be performed by processing unit 420 (FIG. 4). As shown in FIG. 6, rating manager 222 may include ratings aggregator 610, profile manager 620, and reward manager 630.

Ratings aggregator 610 may include hardware or a combination of hardware and software to receive user rating information from one or more video clients 110 and to associate the user ratings information with other information for particular advertisements and/or advertisement campaigns. In one implementation, ratings aggregator 610 may receive user rating information for multiple advertisements simultaneously (e.g., as a batch) and parse the user rating information to associate each rating with other information for particular advertisements.

Profile manager 620 may include hardware or a combination of hardware and software to associate rating information received from video client 110 with other information for that particular video client 110. For example, profile manager 620 may send user rating information to another component within network 200 and to combine user rating information with other tracked user viewing information (e.g., information not associated with advertisement rating) in order to develop a comprehensive profile for an individual video client 110 and/or groups of video clients.

Reward manager 630 may include hardware or a combination of hardware and software to manage incentive programs for obtaining viewer ratings. For example, reward manager 630 may store (e.g., in main memory 430) reward program criteria, rules, and updates and send the program criteria, rules, and updates to video client 110. Reward manager 630 may also apply rules to particular rating information received from video client data to identify rewards earned by viewers. Reward manger 630 may also communicate reward information to video client 110 and/or other components of network 200 to apply an earned reward to the video client 110 (e.g., provide billing credit for an account associated with video client 110, supply a coupon code to video client 110, grant video client 110 access to premium content, etc.)

Although FIG. 6 shows exemplary functional components of rating manager 222, in other implementations, rating manager 222 may contain fewer, different, differently arranged, or additional functional components than depicted in FIG. 6. In still other implementations, one or more functional components of rating manager 222 may perform one or more other tasks described as being performed by one or more other functional components of rating manager 222.

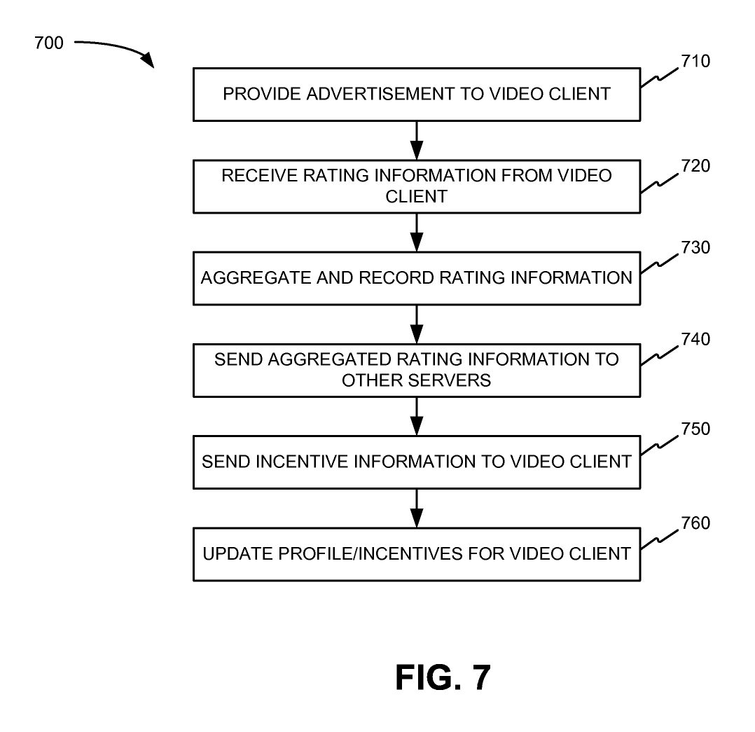

FIG. 7 provides a flow chart of an exemplary process 700 for obtaining viewer feedback of television advertising according to implementations described herein. In one implementation, some or all of process 700 may be performed by one or more devices associated with a subscription multimedia service, such as rating manager 222 and/or content delivery system 210. In other implementations, some or all of process 700 may be performed by another device or group of devices associated with a subscription multimedia service.

Process 700 may include providing an advertisement to a video client (block 710). For example, as described above in connection with FIG. 5, content delivery system 210 may provide linear/interactive advertising content 510 to video client 110. In one implementation, content delivery system 210 may combine linear advertising content with linear broadcast content and send the combined content to video client 110 via access network 280. Linear/interactive advertising content 510 may be supplied to content delivery system 210, for example, via content server 205, linear advertising content database 230, and/or interactive advertising content database 235. Linear/interactive advertising content 510 may be provided to video client 110 as a single video stream integrated with particular program content. In another implementation, content delivery system 210 may provide linear/interactive advertising content 510 separate from any program content, so that linear/interactive advertising content 510 may later be associated with the program content by video client 110.

Returning to FIG. 7, rating information may be received from the video client (block 720), rating information may be aggregated and recorded (block 730), and the aggregated rating information may be sent to other servers (block 740). For example, as described above in connection with FIG. 5, ratings aggregation and processing module 220 may receive user rating information 530 and compile user rating information 530 with other user rating information. In one implementation, ratings aggregation and processing module 220 may provide rating data 540 to advertisers (such as ad sources 240), content providers (such as content sources 260), or others systems within or outside of network 200. Rating data 540 may be provided in a variety of formats and may be combined with other data retrieved from video clients 110.

Again referring to FIG. 7, incentive information may be sent to the video client (block 750) and profile/incentive information for the video client may be updated (block 760). For example, as described above in connection with FIG. 5, ratings aggregation and processing module 220 may also determine an appropriate response to user rating information 530 based on, for example, a set of incentive rules and/or prevailing environmental/contextual metrics (e.g., time of day, program being viewed, etc.). Based on the appropriate response determined by ratings aggregation and processing module 220, ratings aggregation and processing module 220 may provide incentive information 550 to video client 110. Rating manager 222 of ratings aggregation and processing module 220 may, for example, instruct video client 110 to announce a particular reward (e.g., coupons, rebates, price reductions, access to additional content, etc.) available to a viewer and/or a status of progress toward a particular reward. As indicated by reference number 560, rating manager 222 may send the updates for a user profile to another location either within ratings aggregation and processing module 220 (e.g., data logger 224) or to another data collection/analyzing component within network 200.

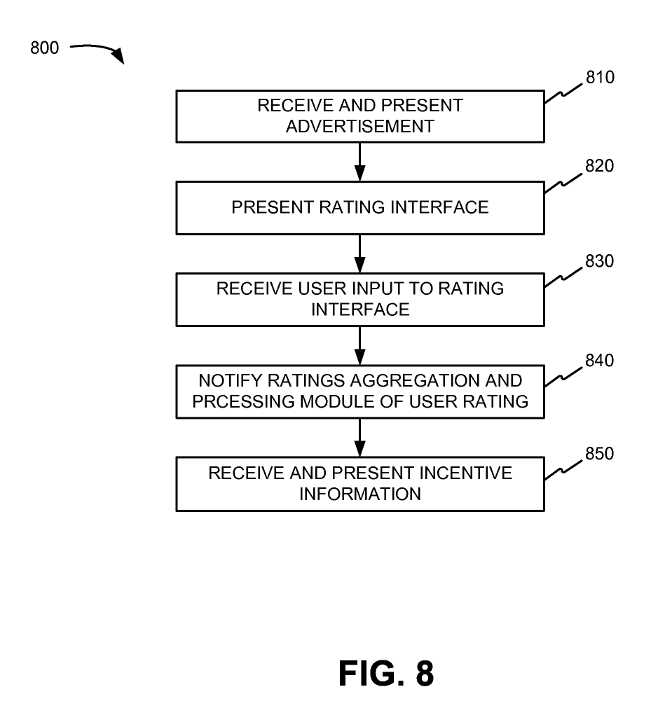

FIG. 8 provides a flow chart of another exemplary process 800 for obtaining viewer feedback of television advertising according to implementations described herein. In one implementation, some or all of process 800 may be performed by a video client, such as video client 110, associated with a subscription multimedia service. In other implementations, some or all of process 800 may be performed by video client 110 in conjunction with one or more servers, such as rating manager 222.

Process 800 may include receiving and presenting an advertisement (block 810). For example, video client 110 may receive from content delivery system 210 an advertisement included within a linear broadcast stream. In another implementation, video client 110 may request (e.g., based on user input via remote control 150) a particular primary advertisement from content server 205, such as a previously bookmarked advertisement selected from a list of bookmarked advertisements. The advertisement may be presented to the user on a display (e.g., video display 120).

A rating interface may be presented (block 820) and user input to the rating interface may be received (block 830). For example, as described above in connection with FIG. 5, video client 110 may receive linear/interactive advertising content 510 and may cause the advertising content to be displayed to a user (e.g., via video display device 120). When an advertisement is displayed, video client 110 may also initiate display of a rating interface (e.g., rating interface 140). A viewer may provide a user rating input 520 to video client 110 via the rating interface. User rating input 520 may be provided via a remote control (e.g., remote control 150).

In an exemplary implementation, video client 110 may also implement DVR capabilities to store linear programming content upon receiving user input to the rating interface. For example, advertisement 130 may be paused at the point in time at which a user activates the rating interface or provides an input signal to the activated user interface. Video client 110 may store subsequent linear content (e.g., program content and/or linear advertising) from that point in time forward.

The ratings aggregation and processing module may be notified of the user rating (block 840). For example, as described above in connection with FIG. 5, video client 110 may identify user rating input 520 and associate user rating input 520 with an identification code for the advertisement, time/channel information, an identification code for video client 110, and/or other contextual information. Video client 110 may compile the identification code for the advertisement, time/channel information, identification code for video client 110, and/or other contextual information and send the compiled user rating information to ratings aggregation and processing module 220, as indicated by reference number 530. In one implementation, user rating information 530 may be provided to ratings aggregation and processing module 220 in real time (or near real time). In other implementations, user rating information 530 may be provided as a batch of rating inputs (e.g., provided at particular intervals and/or when requested by ratings aggregation and processing module 220).

Incentive information may be received and presented (block 850). For example, video client 110 may provide, via rating interface 140, messages to keep the viewer interested and motivated to continue viewing advertisements. In one implementation, video client 110 may retrieve information to be presented from a local memory (e.g., memory 320). In another implementation, video client 110 may receive information to be presented from another device or group of devices, such as ratings aggregation and processing module 220.

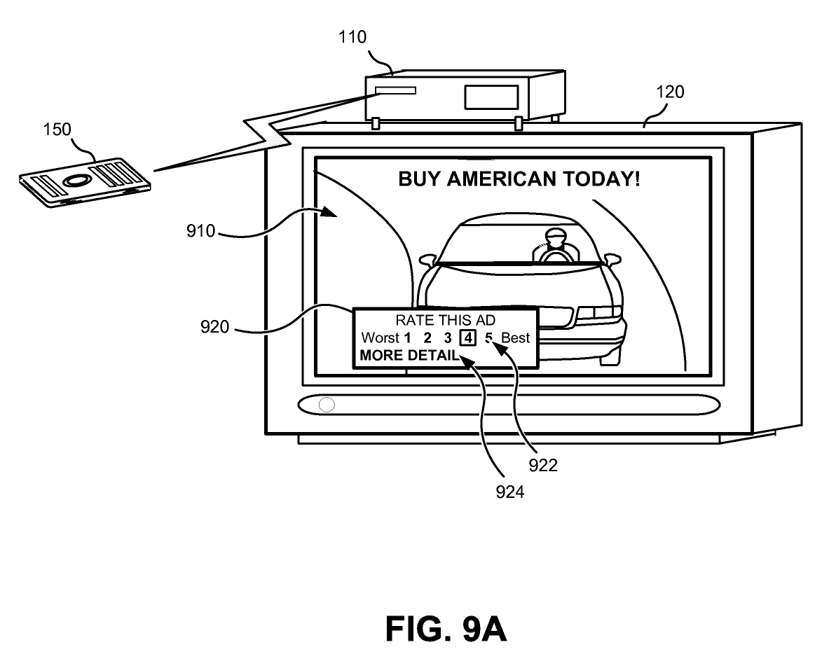

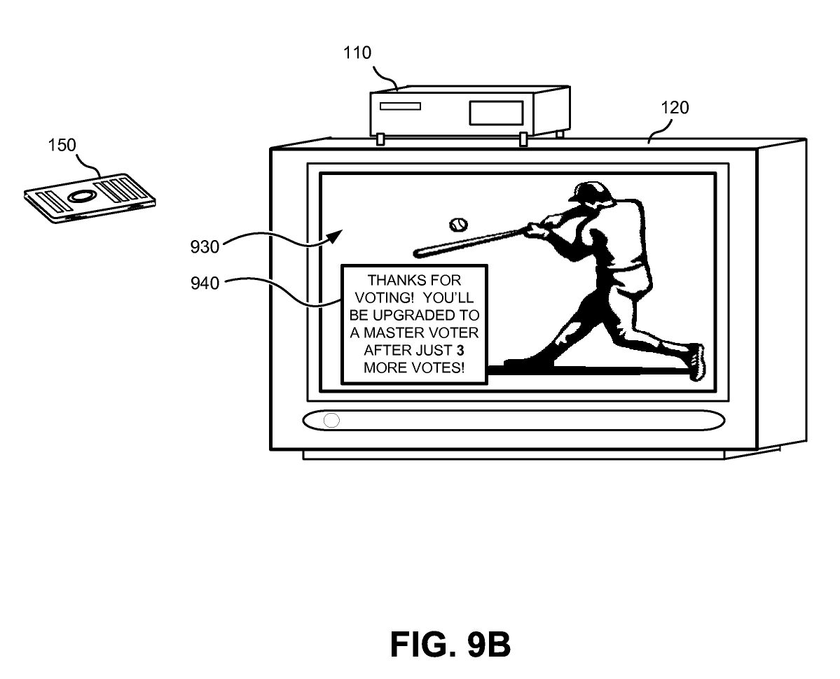

FIGS. 9A and 9B provide exemplary diagrams illustrating implementations of a user interface for obtaining viewer feedback of television advertising. More specifically, FIG. 9A provides an exemplary diagram of an on-screen interface that may be displayed to solicit viewer input during an advertisement, and FIG. 9B provides an exemplary diagram of an on-screen interface that may be displayed in response to the viewer input.

Referring to FIG. 9A, a viewer may view a display on video display device 120 that presents an advertisement 910. Advertisement 910 may be, for example, a linear advertisement that is presented during a break in program content (e.g., a conventional commercial break). As shown in FIG. 9A, a rating interface 920 may be displayed simultaneously during at least a portion of advertisement 910. In one implementation, rating interface 920 may be automatically presented during the advertisement if a viewer, for example, has activated a rating interface feature within video client 110. In another implementation, a viewer may cause rating interface 920 to be displayed by pressing a particular button on remote control 150 during display of advertisement 910.

Rating interface 920 may include an interactive menu that can be implemented, for example, via EBIF. In one implementation, rating interface 920 may include rating indicators 922 that may be selected via remote control 150 to allow a user to provide input. Rating indicators 922 may include, for example, qualitative words/images (e.g., “like it/don't like it,” thumbs up/thumbs down, various emoticons, etc.) or quantitative ranges (e.g., a rating scale of 1 to 5, where 1 indicates a poor rating and 5 indicates a high rating). In general, rating interface 920 may be configured to allow a viewer to quickly provide rating input in an unobtrusive manner. In some implementations, rating interface 920 may include a selection option 924 to provide a more detailed rating for advertisement 910. Selection option 924 may provide access to a more detailed rating interface menu that may allow, for example, textual comments from the viewer.

In one implementation, rating-input from the viewer (such as pressing a button on remote control 150 to activate rating interface 920, provide a rating value within rating interface 920, or choose the more detailed rating interface menu) may cause video client 110 to pause the display of advertisement 910. In an exemplary implementation, content that continues to be broadcast to video client 110 during the pause period may be stored in a memory (e.g., memory 320) of video client 110 (e.g., using DVR functionality).

As shown in FIG. 9B, programming 930 (e.g., additional advertising and/or program content) may continue to be presented on video display device 120 after the user input to rating interface 920 has been entered. Based on the user input to rating interface 920, a response message 940 may be presented on video display device 120. Response message 940 may include additional a message to indicate the rating input was successfully entered and/or a status of incentive related to the rating system.

As another example, a viewer may receive access to additional (e.g., premium) content for watching and rating advertisements. The additional content may be, for example, additional advertisements within an advertising campaign so that watching advertising is transformed into a form of gaming. In other words, viewers can accumulate points and/or access to successively “higher” levels of an advertising campaign. Moreover, viewers can view with one another for status based on tier level achieved (e.g., the ratings interface 940 may provide statistics for user groups and even provide for chatting and other interaction among group members). Advantageously, this interactive rating can make advertising campaigns “sticky” as viewer communities may be formed around popular advertisements.

The illustrations of FIGS. 9A and 9B provide exemplary formats for obtaining viewer feedback of television advertising. Other formats and variations may be used.

Implementations described herein may provide systems and/or methods that receives an advertisement for presentation on a display and presents to a user, on the display, the advertisement and a rating interface for the advertisement. The systems and/or methods may receive, via the rating interface, a user input to rate the advertisement and send, to a server, rating information based on the user input to rate the advertisement. The systems and/or methods may also receive, from the server, incentive information based on the rating information and present to the user, on the display, the incentive information. Such systems and/or methods may generate interest in advertising campaigns and thereby increase the value of advertising timeslots and raise advertising revenues for multimedia service providers.

The foregoing description provides illustration and description, but is not intended to be exhaustive or to limit the implementations to the precise form disclosed. Modifications and variations are possible in light of the above teachings or may be acquired from practice of systems and/or methods disclosed herein.

For example, while series of blocks have been described with regard to the flowcharts of FIGS. 7 and 8, the order of the blocks may differ in other implementations. Further, non-dependent blocks may be performed in parallel.

It will be apparent that exemplary aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Even though particular combinations of features are recited in the claims and/or disclosed in the specification, these combinations are not intended to limit the invention. In fact, many of these features may be combined in ways not specifically recited in the claims and/or disclosed in the specification.

No element, block, or instruction used in the present application should be construed as critical or essential to the invention unless explicitly described as such. Also, as used herein, the article “a” is intended to include one or more items. Where only one item is intended, the term “one” or similar language is used. Further, the phrase “based on,” as used herein is intended to mean “based, at least in part, on” unless explicitly stated otherwise.

What is claimed is:

1. A method performed by one or more devices within a subscription multimedia service network, comprising:
sending, by one of the one or more devices and via the subscription multimedia service network, an advertisement for presentation by a video client;
receiving, from the video client and via the subscription multimedia service network, rating information that includes a viewer rating of the advertisement;
aggregating, by one of the one or more devices, the rating information with other rating information for the advertisement;
sending, by one of the one or more devices, the aggregated rating information to a server; and
sending, to the video client and by one of the one or more devices, incentive information based on the rating information.

2. The method of claim 1, further comprising:
storing, in a memory of one of the one or more devices, metrics regarding the rating information.

3. The method of claim 1, where the incentive information includes at least one of:
a notification of a reward earned by the viewer of the video client, or a notification of a change of status of the viewer with respect to an incentive.

4. The method of claim 1, where the reward includes one or more of:
a coupon for additional services within the subscription multimedia service network,
a coupon for advertiser products or services,
a rebate for services received within the subscription multimedia service network, or
access rights to additional multimedia content.

5. The method of claim 1, where the viewer rating of the advertisement is obtained via an on-screen rating interface generated by the video client.

6. The method of claim 1, where the advertisement is included in a linear programming stream.

7. The method of claim 1, where the advertisement includes at least one of:
a non-linear advertisement, or
an interactive application.

8. A system, comprising:
a memory to store instructions; and
a processor to execute the instructions to:
receive, from a video client and via a network, rating information that includes a viewer rating of an advertisement presented on a display to the viewer by the video client;
aggregate the rating information with other rating information for the advertisement;
update a rating incentive profile associated with the video client based on the rating information; and
send, to the video client and via the network, incentive information based on the rating information.

9. The system of claim 8, where the processor is further to:
store, in the memory, metrics regarding the user rating information.

10. The system of claim 8, where the processor is further to:
send the aggregated rating information to an advertisement source.

11. The system of claim 8, where the rating information further includes one or more of:
an advertisement identifier,
time information for the advertisement,
time information for the viewer rating, or
channel information for the advertisement.

12. The system of claim 8, where the viewer rating of the advertisement is obtained via an on-screen rating interface generated by the video client.

13. A method implemented by a video client, comprising:
receiving, by the video client, an advertisement for presentation on a display;
presenting, to a user and on the display, the advertisement and a rating interface for the advertisement;
receiving, by the video client and via the rating interface, a user input that rates the advertisement;
sending, by the video client and to a server, rating information based on the user input that rates the advertisement;
receiving, by the video client and from the server, incentive information based on the rating information; and
presenting, to the user and on the display, the incentive information.

14. The method of claim 13, further comprising:
receiving, by the video client, criteria for a rating incentive program; and
comparing, by the video client, metrics from the user input against the criteria.

15. The method of claim 13, where the incentive information includes at least one of:
a notification of a reward earned by the user of the video client, or
a notification of a change of status of the user with respect to an incentive.

16. The method of claim 13, where the rating interface includes an interactive menu to solicit input from the user via a remote control.

17. The method of claim 13, further comprising:
pausing the presentation of the advertisement upon receiving the user input;
recording a subsequent stream of linear programming when the presentation of the advertisement is paused; and
resuming presentation of the advertisement upon completion of the user input.

18. A system, comprising:
a memory to store instructions; and
a processor to execute the instructions to:
receive, via a subscription multimedia service network, an advertisement for presentation on a display;
present, to a user and on the display, the advertisement and a rating interface to solicit user input for the advertisement;
receive, via the rating interface, user input that rates the advertisement;
send, to a server and via the subscription multimedia service network, rating information based on the user input that rates the advertisement;
receive, via the subscription multimedia service network, incentive information based on the rating information; and
present, to the user and on the display, the incentive information

19. The system of claim 18, where the rating information includes one or more of:
a rating value for the advertisement,
an advertisement identifier,
time information for the advertisement,
time information for the user rating, or
channel information for the advertisement.

20. The system of claim 18, where the processor further executes instructions in the memory to:
automatically activate the rating interface when presenting the advertisement.

21. A system, comprising:
one or more devices provided within a network for subscription multimedia service provider, the one or more devices comprising:
means for providing an advertisement for presentation to a viewer by a video client;
means for presenting to the viewer, on a display, the advertisement and a rating interface for the advertisement;
means for receiving a viewer rating of the advertisement;
means for aggregating the rating information with other rating information for the advertisement;
means for providing the aggregated rating information to an advertisement source; and
means for generating incentive information for the viewer based on the viewer rating.

22. The system of claim 21, where the incentive information includes one or more of:
a notification of a reward earned by the viewer, or
a notification of a change of status of the viewer with respect to an incentive.

23. The system of claim 21, further comprising:
means for storing metrics regarding the viewer rating.
